(19) United States
(12) Patent Application Publication
(10) Pub. No.: US 2007/0188811 A1
(43) Pub. Date: Aug. 16, 2007

(54) Document processing apparatus and document processing method

(75) Inventor: Yoshihiro Terada, Kanagawa (JP)

Correspondence Address: OLIFF & BERRIDGE, PLC, P.O. BOX 19928, ALEXANDRIA, VA, 22320, US

(73) Assignee: FUJI XERO CO., LTD., TOKYO (JP)

(21) Appl. No.: 11/542,210

(22) Filed: Oct. 4, 2006

(30) Foreign Application Priority Data
Feb. 15, 2006 (JP) 2006-038043

(51) Int. Cl. G06K 15/00

(52) U.S. Cl. 358/2.1

(57) ABSTRACT

A document processing apparatus for processing an image read from an original document, which includes an electronic tag recording section that records information to an electronic tag, and when processing using the original document having the electronic tag is performed, records a processing history related to the processing into the electronic tag.

### BACKGROUND

1. Technical Field

The present invention relates to a document processing apparatus and a document processing method, more particularly relates to the document processing apparatus and the document processing method, which prevent leakage of a confidential document and the like.

2. Related Art

As color copying machines and color printing machines are becoming high quality and multifunction, while copying or distributing high image quality documents at a higher speed has been possible, there has arisen problems of outflow or leakage of document information related to confidential documents.

Among others, recently, as network functions of multifunction machines have progressed, and the network infrastructure for overall society has been established and improved, it becomes possible to digitize a confidential document using multifunction machines, and send them through the network without bringing the confidential document or duplication thereof out of offices.

### SUMMARY

An aspect of the present invention provides a document processing apparatus for processing an image read from an original document, which includes an electronic tag recording section that records information to an electronic tag, and when processing using the original document having the electronic tag is performed, records a processing history related to the processing to the electronic tag.

### BRIEF DESCRIPTION OF THE DRAWINGS

An exemplary embodiment of the present invention will be described in detail based on the following figures, wherein:

FIG. 1 is a functional block diagram showing one example of a configuration of a document processing apparatus according to the present invention;

FIGS. 2A and 2B are diagrams showing installation examples of an electronic tag reader/writer; and

FIG. 3 is a flow chart showing one example of a processing flow in the image processing apparatus.

### DETAILED DESCRIPTION

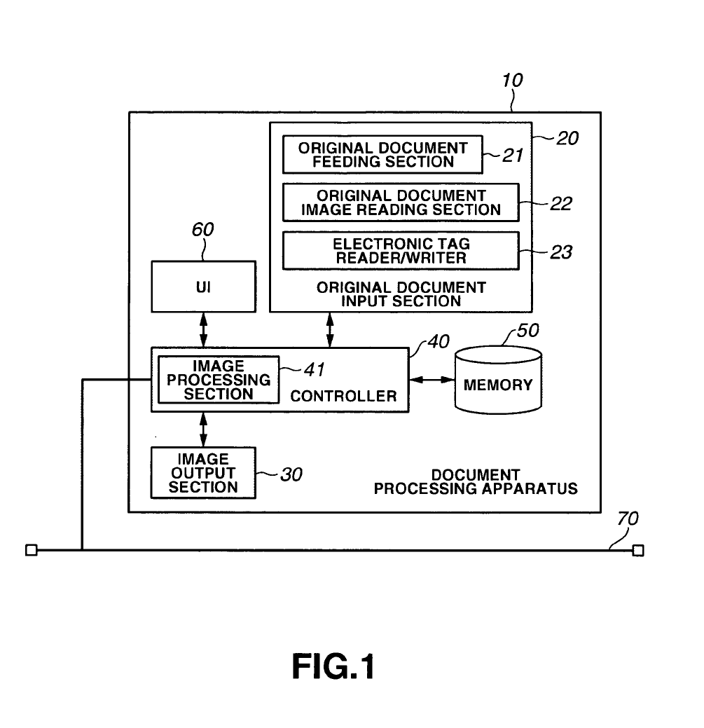

FIG. 1 is a functional block diagram showing one example of configuration of a document processing apparatus according to the present invention

As shown in FIG. 1, a document processing apparatus 10 includes an original document input section 20 that scans an original document and reads an image, an image output section 30 that prints out the image, a controller 40 that performs a process for controlling the overall document processing apparatus, a memory 50 configured with a storing unit or a HDD (Hard Disk Drive) and the like, and has a UI (User Interface) 60 that includes a touch panel and the like, and displays information to be provided to a user and receives an operation performed by the user. And the document processing apparatus 10 is connected with a network 70 such as a LAN (Local Area Network) or the Internet.

Additionally, the original document input section 20 is provided with an original document feeding section 21 that feeds the original document, an original document image reading section 22 that scans the original document and reads the image, and an electronic tag reader/writer 23 that reads information from or writes the information to an electronic tag provided to the original document.

Additionally, the electronic tag (IC chip) provided to the original document is an IC chip such as RFID (Radio Frequency ID), a wireless tag, an IC tag or the like that can read and write data in a non-contact manner. Furthermore, the electronic tag can be provide to the original document in an arbitrary way such as a way of attaching the IC chip to the original document like a label, embedding an ultrafine IC chip in a paper sheet, or the like.

Here, the original document feeding section 21 includes an automatic document feeder (ADF), an original document reversing section that flips the original document over to its backside, and the like, and feeds the original document so that the original document image reading section 22 that reads the image can scan a side-to-be-scanned of the original document.

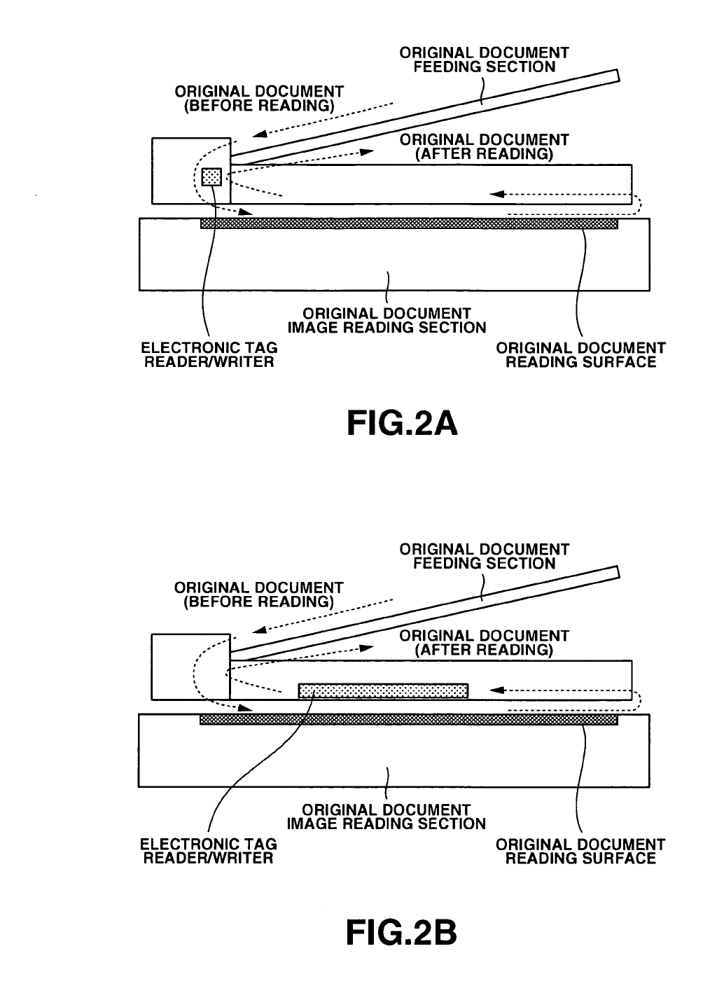

Additionally, the electronic tag reader/writer 23 is placed, as shown in FIGS. 2A and 2B, in a position where, when the original document is placed on an original document feeding path (see FIG. 2A) or on a platen (original document reading section), reading from or writing to the electronic tag can be performed (see FIG. 2B).

The controller 40 is provided with an image processing section 41 that carries out processing of a scanned image obtained by scanning and reading the original document, of an image received via a facsimile, of a print document instructed to print out or the like, and generates image data for printing out an image by the image output section 30.

Using the above-stated configuration, in the document processing apparatus 10 of the present invention, after plural original documents are set in the original document feeding section 21 and instruction to read the original documents is given from the UI, the original document image reading section 22 scans the original documents and reads images, the image processing section 41 generates image data, and the image output section 30 prints out the image, or the image data is transmitted through the network 70.

Additionally, the electronic tag reader/writer 23 reads the electronic tag provided to the original document, and the document processing apparatus 10 records the history of the processing of the original document into the electronic tag provided to the original document, and to the memory 50.

Here, as the processing history, for example, functions, such as a copy, a scan, or a facsimile function, which are used in the document processing apparatus and settings thereof, user identification information, such as an account, an ID, of a user who uses the document processing apparatus, identification information of the document processing apparatus such as time, a model name or a serial number of the document processing apparatus, or the like may be used.

Additionally, when a title or other information (identification information) that can identify an original document is recorded in the electronic tag, the information may be recorded in the document processing apparatus by including the information into the processing history.

Furthermore, an image of a part of the original document (for example, the first line of the document or the like) may be recorded in the document processing apparatus by including that image in the processing history through applying OCR (Optical Character Reader) processing to the image for converting into a text.

Moreover, when the electronic tag reader/writer is provided only to the ADF, the apparatus may be configured to limit user's processing operation of the document processing apparatus to a processing operation in which the electronic tag can be read/written, such that a unit that can detect the electronic tag is installed to the platen, and when the electronic tag is detected in the platen, a processing operation that the user can use is limited to a processing operation that uses the ADF.

Additionally, when processing is performed for both sides of the original document in which a document or the like is printed on both sides, the apparatus may be configured to change processing for the electronic tag (access operation) between in a case that processing is performed for only one side of the original document and in a case that processing is performed for both sides, such that, in a case of processing for a front side, information that processing is performed for both sides is recorded, and in a case of processing for a back side, reading from or writing to the electronic tag is not performed.

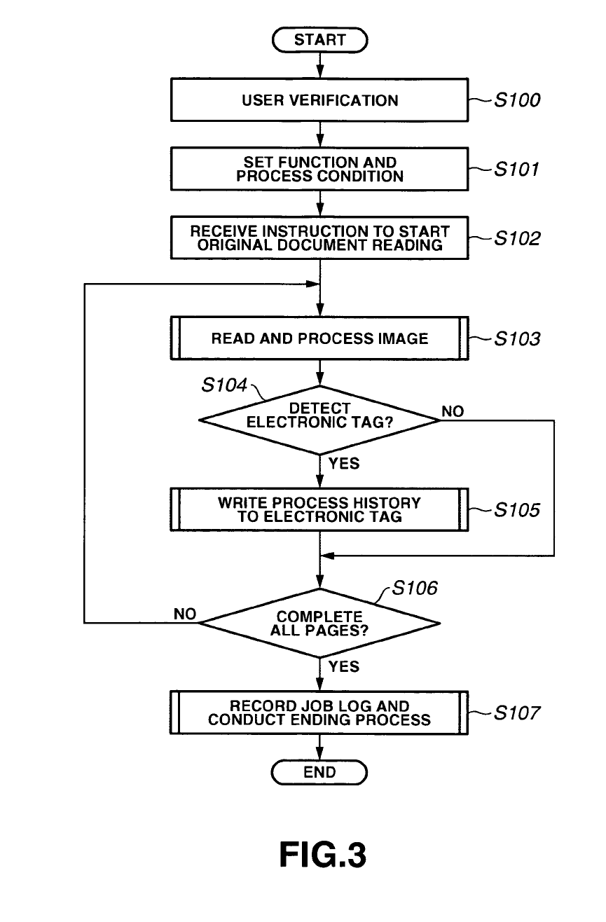

FIG. 3 is a flow chart showing one example of a processing flow in an image processing apparatus pertaining to the present invention.

First, user verification is carried out for the utilization of the image processing apparatus (Step 100), an original document is set to the ADF, a function (copy, scanner, facsimile and the like) is selected to use the image processing apparatus, processing condition for the function is inputted, and setting for the function to be used and processing condition is performed (Step 101).

Next, after an instruction to start to read the original document is given (Step 102), one sheet of the original document is scanned and an image is read, and then processing according to the set function is performed for the read image (Step 103).

Next, a determination whether or not the original document has the electronic tag is performed (Step 104), and when it is determined that the document has the electronic tag (YES in Step 104), the processing history is recorded into the electronic tag (Step 105), and the determination whether or not all the pages that are set in the ADF are completed is performed (Step 106).

On the other hand, when it is determined in Step 104 that the original document does not have the electronic tag, the determination whether or not all the pages that are set in the ADF are completed is performed (Step 106).

Then, when it is determined in Step 106 that the processing of all the pages that are set in the ADF is not yet completed (NO in Step 106), the next sheet of the original document is scanned and the image is read, and then processing according to the set function is performed for the read image (Step 103).

Then, when it is determined in Step 106 that all the pages that are set in the ADF are completed (YES in Step 106), a job log (processing history) is recorded, and ending process is performed to end the processing (Step 107).

Additionally, the user verification can be conducted using arbitrary methods, such as a method of inputting a user ID and a password that are stored in the image processing apparatus records from the UI, a method of matching a user account that is registered in an outside server via the network, and a method of conducting the user verification using ID card or the like through an external dedicated unit connected to the image processing apparatus.

Additionally, as processing conditions, arbitrary processing conditions may be applied for the function used in the image processing apparatus, for example:

in a case of the copy: number of copy, size of sheet, setting of side, scale up/down ratio, color mode, type of original document, N-up, or the like,

in a case of the facsimile: distribution destination, setting of side, scale up/down ratio, resolution, encoding setting such as G3/G4, type of original document, N-up, or the like,

in a case of the scanner: mail distribution destination, file storage destination, setting of side, scale up/down ratio, resolution, file format, color mode, type of original document, N-up, or the like.

As stated above, in the present invention, since the history of the processing is recorded in the original document for which the processing is performed, and when confidential information is leaked, source of the leakage of the confidential information can be surely identified from the original document.

Additionally, as a job history in the document processing apparatus, since the record of processing of the original document having the electronic tag is kept, it is possible for an administrator to know the possibility of leakage of the confidential information at a time of job collecting or maintenance of the document processing apparatus, and when the leakage of the confidential information occurs, it is expected to identify the source of the leakage of the confidential information from the document processing apparatus.

Additionally, because the source of the leakage of the confidential information can be identified from the original document or the document processing apparatus, it is expected to deter potential information leakage itself.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus for processing an image read from an original document, comprising:
an electronic tag recording section that records information to an electronic tag, and when processing using the original document having the electronic tag is performed, the electronic tag recording section records a processing history related to the processing into the electronic tag.

2. The document processing apparatus according to claim 1, wherein the processing history includes at least one of a function that is used, setting information related to the function, user identification information, time, and identification information of the document processing apparatus.

3. The document processing apparatus according to claim 1, further comprising:
a memory that stores the processing history; and
a processing history recording section that records the processing history in the memory, and
wherein the processing history recording section records the processing history in the memory.

4. The document processing apparatus according to claim 3, further comprising:
an electronic tag reading section that obtains information for identifying the original document from the electronic tag,
wherein:
the processing history recording section records original document identification information in the memory.

5. The document processing apparatus according to claim 1, further comprising:
a detection section that detects the electronic tag; and
a limitation section that, when the detection section detects the electronic tag, controls so that a processing operation using the original document in which the recording section cannot records information to the electric tag is not performed.

6. The document processing apparatus according to claim 1, wherein
an access operation to the electronic tag is varied in accordance with whether the image is read from one side of the original document or from both sides of the original document.

7. The document processing apparatus according to claim 2, wherein
an access operation to the electronic tag is varied in accordance with whether the image is read from one side of the original document or from both sides of the original document.

8. A document processing method for processing an image read from an original document, comprising:
when a processing using the original document having an electronic tag is performed,
recording a processing history related to the processing to the electronic tag.
